(19) United States
(12) Patent Application Publication
(10) Pub. No.: US 2017/0213208 A1
(43) Pub. Date: Jul. 27, 2017

(54) METHODS, SYSTEMS, NETWORKS, AND MEDIA FOR PREDICTING ACCEPTANCE OF A COMMERCIAL CARD PRODUCT

(71) Applicant: MASTERCARD INTERNATIONAL INCORPORATED, Purchase, NY (US)

(72) Inventors: Edward Francis Downs, River Vale, NJ (US); Andisya N. Siregar, New York, NY (US); Robert Snyder, Monsey, NY (US)

(73) Assignee: MASTERCARD INTERNATIONAL INCORPORATED, Purchase, NY (US)

(21) Appl. No.: 15/007,655

(22) Filed: Jan. 27, 2016

(51) Int. Cl. G06Q 20/38; G06Q 20/34

(52) U.S. Cl. CPC G06Q 20/38; G06Q 20/34

(57) ABSTRACT

Method for predicting acceptance of a commercial card product can include obtaining data representing a plurality of variables related to payment card transactions for at least one merchant. Each of the plurality of variables can be weighted. Scores for each of the plurality of variables can be assigned based on at least one predetermined threshold. An acceptance score for each merchant can be calculated by combining the scores for each of the plurality of variables for each merchant. Whether each merchant is likely to accept a commercial card product can be predicted based on the acceptance score. Each merchant predicted to be likely to accept the commercial card product can be contacted. Systems, networks, and media are also disclosed.

### BACKGROUND

The disclosed subject matter relates to methods, systems, networks, and media for predicting acceptance of a commercial card product, including calculating an acceptance score.

Certain merchants can disfavor payment card and/or commercial card products. Other merchants can treat commercial card products of corporate or commercial customers differently than payment card products of individual consumers. For example, such merchants may be more willing to accept payment cards from individual customers but prefer not to accept commercial card products from commercial customers for business-to-business (B2B) transactions (e.g., in favor of other forms of payment). Recently, issuers have increased interest in helping their corporate customers to optimize their commercial card programs (e.g., purchasing and/or electronically payable) by broadening commercial card acceptance with B2B merchants. Issuers can be interested in increasing their customer's card penetration with key B2B merchants. For example, issuers can request information pertaining to B2B merchants from payment network service providers.

Techniques for determining whether a merchant accepts payment cards are known. These existing techniques can include maintaining a list or database of information identifying merchants who are acceptors of payment cards, for example and not limitation, including merchant names and address information. For purpose of illustration, one such technique can include the MasterCard® Merchant Match Tool (MMT), which can allow an issuers to identify whether one or more merchants are currently accepting MasterCard payment card transactions. However, such techniques can fail to provide accurate information regarding whether the merchant(s) will be willing to accept commercial card transactions from other commercial customers. Such techniques can lack a sufficient level of insight that allows issuers to prioritize their customer list and come up with an effective go-to-market strategy to target B2B merchants effectively.

Accordingly, there exists a need for improved techniques for predicting acceptance of a commercial card product, including predicting whether B2B merchants are likely to accept commercial card products from other commercial customers.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a method for predicting acceptance of a commercial card product is disclosed. The method can include obtaining data representing a plurality of variables related to payment card transactions for at least one merchant. Each of the plurality of variables can be weighted. Scores for each of the plurality of variables can be assigned based on at least one predetermined threshold. An acceptance score for each merchant can be calculated by combining the scores for each of the plurality of variables for each merchant. Whether each merchant is likely to accept a commercial card product can be predicted based on the acceptance score. Additionally, each merchant predicted to be likely to accept the commercial card product can be contacted.

For purpose of illustration and not limitation, obtaining the data representing the plurality of variables can include accessing the data representing the plurality of variables from a database. Additionally or alternatively, obtaining the data representing the plurality of variables can include automatically capturing the data representing the plurality of variables from a payment network and storing the data representing the plurality of variables in a database.

As embodied herein, the data representing the plurality of variables can include at least one of each merchant's share of transactions in a merchant category code (MCC), each merchant's share of volume in the MCC, each merchant's average transaction size, each merchant's variance of volume trend, each merchant's effective rate qualification, and each merchant's issuer concentration. For example and not limitation, each merchant's share of transactions in the MCC can be each merchant's total number of transactions divided by a total number of transactions in the MCC. Each merchant's share of volume in the MCC can be each merchant's total volume in currency divided by total volume in currency in the MCC. Each merchant's average transaction size can be each merchant's total volume divided by each merchant's total number of transactions. Each merchant's variance of volume trend can be each merchant's volume change in a current time period minus each merchant's volume change in a previous time period. Each merchant's effective rate qualification can be each merchant's issuing interchange fee divided by each merchant's total volume. Each merchant's issuer concentration can be each merchant's issuer volume divided by each merchant's total volume in the current time period minus each merchant's issuer volume divided by each merchant's total volume of the previous time period. For purpose of illustration and not limitation, the current time period can be a rolling 12 month period, and the previous time period can be a 12 month period prior to the rolling 12 month period. Alternatively, the current time period can be a year to date, and the previous time period can be a prior year to date.

Additionally, the data representing the plurality of variables comprises data from external sources. For example and not limitation, the data from external sources can include at least one of an industry concentration of each merchant and each merchant's amount of card acceptance volume relative to total accounts receivables.

For purpose of illustration and not limitation, weighting each of the plurality of variables can include ranking each of the plurality of variables in order of importance and determining a weight for each of the plurality of variables based on a rank of each of the plurality of variables. Additionally or alternatively, assigning scores for each of the plurality of variables based on at least one predetermined threshold can include selecting at least one threshold for each of the plurality of variables and determining a score for each of the plurality of variables based on whether each of the plurality of variables is greater than or less than each respective threshold. For example and not limitation, selecting at least one threshold can include selecting a plurality of thresholds for each of the plurality of variables. Additionally, determining the score can include determining the score for each of the plurality of variables based on whether each of the plurality of variables is greater than, less than, or between each respective plurality of thresholds.

For example and not limitation, calculating the acceptance score for each merchant can include calculating a sum of the scores for each of the plurality of variables for each merchant. Additionally or alternatively, calculating the acceptance score for each merchant can include calculating an average of the scores for each of the plurality of variables for each merchant.

For purpose of illustration and not limitation, predicting whether each merchant is likely to accept the commercial card product can include determining whether the acceptance score is greater than a score threshold. Additionally or alternatively, predicting whether each merchant is likely to accept the commercial card product can include determining whether the acceptance score is greater than a high likelihood score threshold, determining whether the acceptance score is between the high likelihood score threshold and a low likelihood score threshold, or determining whether the acceptance score is below the low likelihood score threshold.

As embodied herein, contacting each merchant predicted to be likely to accept the commercial card product can include at least one of a payment network service provider directly contacting each merchant predicted to be likely to accept the commercial card, the payment network service provider providing information identifying each merchant predicted to be likely to accept the commercial card to an issuer to contact each merchant predicted to be likely to accept the commercial card, or the issuer providing the information identifying each merchant predicted to be likely to accept the commercial card to a commercial customer of the issuer to contact each merchant predicted to be likely to accept the commercial card.

In accordance with another aspect of the disclosed subject matter, a system for predicting acceptance of a commercial card product is disclosed. The system can include at least one database configured to store data representing a plurality of variables related to payment card transactions for at least one merchant. At least one first server can be coupled to the database and can be configured to weight each of the plurality of variables. Scores for each of the plurality of variables can be assigned based on at least one predetermined threshold. An acceptance score for each merchant can be calculated by combining the scores for each of the plurality of variables for each merchant. Whether each merchant is likely to accept a commercial card product can be predicted based on the acceptance score. Additionally, each merchant predicted to be likely to accept the commercial card product can be contacted.

As embodied herein, at least one payment network server can be connected to a payment network and can be configured to automatically capture the data representing the plurality of variables from the payment network and send the data representing the plurality of variables from the payment network server to the database. Additionally or alternatively, the data representing the plurality of variables comprises data from external sources, and at least one second server can be configured to receive the data from the external sources.

In accordance with another aspect of the disclosed subject matter, a payment network for predicting acceptance of a commercial card product is disclosed. The payment network can include a plurality of merchants connected to at least one electronic payment network. At least one acquirer can be connected to the at least one electronic network, and each merchant can be in communication with at least one acquirer via the payment network. At least one issuer can be connected to the electronic network, and each acquirer can be in communication with at least one issuer via the payment network. At least one payment network server can be connected to the at least one electronic network and can be configured to automatically capture the data representing the plurality of variables from the payment network. At least one database can be configured to receive the data representing the plurality of variables from the payment network server and store the data representing a plurality of variables related to payment card transactions for at least one merchant. At least one first server can be coupled to the at least one database and can be configured to weight each of the plurality of variables. Scores for each of the plurality of variables can be assigned based on at least one predetermined threshold. An acceptance score for each merchant can be calculated by combining the scores for each of the plurality of variables for each merchant. Whether each merchant is likely to accept a commercial card product can be predicted based on the acceptance score. Additionally, each merchant predicted to be likely to accept the commercial card product can be contacted.

In accordance with another aspect of the disclosed subject matter, a non-transitory computer readable medium is disclosed. The non-transitory computer readable medium can include an executable set of instructions to direct a processor to obtain data representing a plurality of variables related to payment card transactions for at least one merchant. Each of the plurality of variables can be weighted. Scores for each of the plurality of variables can be assigned based on at least one predetermined threshold. An acceptance score for each merchant can be calculated by combining the scores for each of the plurality of variables for each merchant. Whether each merchant is likely to accept a commercial card product can be predicted based on the acceptance score. Additionally, each merchant predicted to be likely to accept the commercial card product can be contacted.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIG. 2 is a block diagram illustrating a representative system according to an illustrative embodiment of the disclosed subject matter.

FIG. 3 is a flow chart illustrating a representative method implemented according to an illustrative embodiment of the disclosed subject matter.

FIG. 4 is a block diagram illustrating further details of a representative computer system according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods, systems, networks, and media presented herein can be used for predicting acceptance of a commercial card product. The disclosed subject matter is particularly suited for predicting acceptance of a commercial card product by calculating an acceptance score. For example, a B2B merchant with a higher score can be identified as more likely to accept a commercial card product from additional commercial customers. For purpose of illustration and not limitation, B2B merchants can include any merchant that carries on transactions with commercial customers, including but not limited to carriers, security companies, office supply companies, advertising companies, janitorial companies, landscaping companies, other general business services companies, or companies in any other suitable category of company that completes B2B transactions.

As discussed herein, certain merchants can disfavor or refuse to accept payment card and/or commercial card products. For example, such merchants may be unlikely to accept commercial card products for B2B transactions. The disclosed subject matter can enable assessment of the likelihood that a merchant will accept additional commercial credit card products using a weighted acceptance score, as discussed herein. Additionally, the disclosed subject matter leverages merchant data collected by payment network service providers to allow the service providers or other entities (e.g., issuing banks, also known as issuers) to enhance their customer portfolio by providing a quantifiable prediction of which merchants their customers can target for payment via a commercial card product. As such, issuers or the payment network service providers can use the weighted acceptance score as a tool to identify and target the merchants most likely to acceptance additional commercial card products in their customer portfolio. Accordingly, the disclosed subject matter provides a competitive advantage in the market by giving issuers or the payment network service providers insight into their customers' acceptance data to predict merchants likely to accept additional commercial card products. Such predictive information can be used, for example and not limitation, to create unique go-to-market propositions. For purpose of illustration and not limitation, the payment network service provider can use the disclosed subject matter to provide detailed insights to issuers regarding their portfolio in order to help them expand their B2B business, which in turn can positively impact the payment network service provider's ability to increase share in the issuer's business. Additionally or alternative, the disclosed subject matter can be bundled with or into other products, including by not limited to data analytics products such as MasterCard® Merchant Match Tool, MasterCard® Smart Data, and/or MasterCard® Portfolio Analytics.

In accordance with the disclosed subject matter herein, a method for predicting acceptance of a commercial card product is disclosed. The method can include obtaining data representing a plurality of variables related to payment card transactions for at least one merchant. Each of the plurality of variables can be weighted. Scores for each of the plurality of variables can be assigned based on at least one predetermined threshold. An acceptance score for each merchant can be calculated by combining the scores for each of the plurality of variables for each merchant. Whether each merchant is likely to accept a commercial card product can be predicted based on the acceptance score. Additionally, each merchant predicted to be likely to accept the commercial card product can be contacted.

In accordance with another aspect of the disclosed subject matter, a system for predicting acceptance of a commercial card product is disclosed. The system can include at least one database configured to store data representing a plurality of variables related to payment card transactions for at least one merchant. At least one first server can be coupled to the database and can be configured to weight each of the plurality of variables. Scores for each of the plurality of variables can be assigned based on at least one predetermined threshold. An acceptance score for each merchant can be calculated by combining the scores for each of the plurality of variables for each merchant. Whether each merchant is likely to accept a commercial card product can be predicted based on the acceptance score. Additionally, each merchant predicted to be likely to accept the commercial card product can be contacted.

In accordance with another aspect of the disclosed subject matter, a payment network for predicting acceptance of a commercial card product is disclosed. The payment network can include a plurality of merchants connected to at least one electronic payment network. At least one acquirer can be connected to the at least one electronic network, and each merchant can be in communication with at least one acquirer via the payment network. At least one issuer can be connected to the electronic network, and each acquirer can be in communication with at least one issuer via the payment network. At least one payment network server can be connected to the at least one electronic network and can be configured to automatically capture the data representing the plurality of variables from the payment network. At least one database can be configured to receive the data representing the plurality of variables from the payment network server and store the data representing a plurality of variables related to payment card transactions for at least one merchant. At least one first server can be coupled to the at least one database and can be configured to weight each of the plurality of variables. Scores for each of the plurality of variables can be assigned based on at least one predetermined threshold. An acceptance score for each merchant can be calculated by combining the scores for each of the plurality of variables for each merchant. Whether each merchant is likely to accept a commercial card product can be predicted based on the acceptance score. Additionally, each merchant predicted to be likely to accept the commercial card product can be contacted.

In accordance with another aspect of the disclosed subject matter, a non-transitory computer readable medium is disclosed. The non-transitory computer readable medium can include an executable set of instructions to direct a processor to obtain data representing a plurality of variables related to payment card transactions for at least one merchant. Each of the plurality of variables can be weighted. Scores for each of the plurality of variables can be assigned based on at least one predetermined threshold. An acceptance score for each merchant can be calculated by combining the scores for each of the plurality of variables for each merchant. Whether each merchant is likely to accept a commercial card product can be predicted based on the acceptance score. Additionally, each merchant predicted to be likely to accept the commercial card product can be contacted.

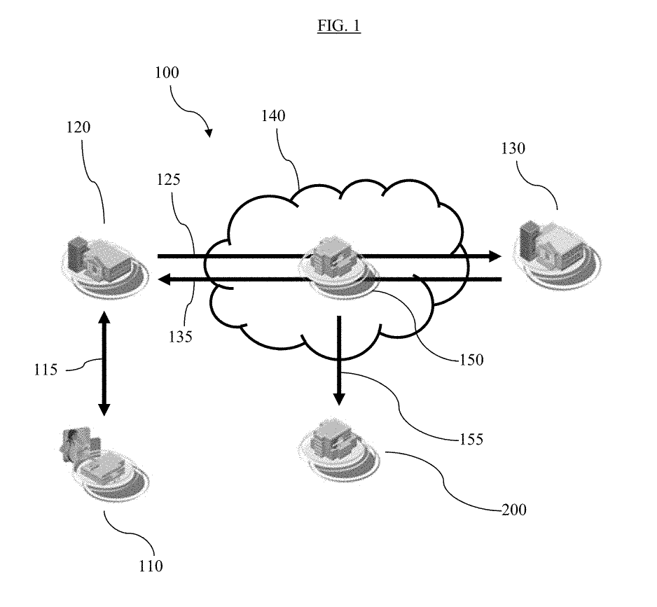

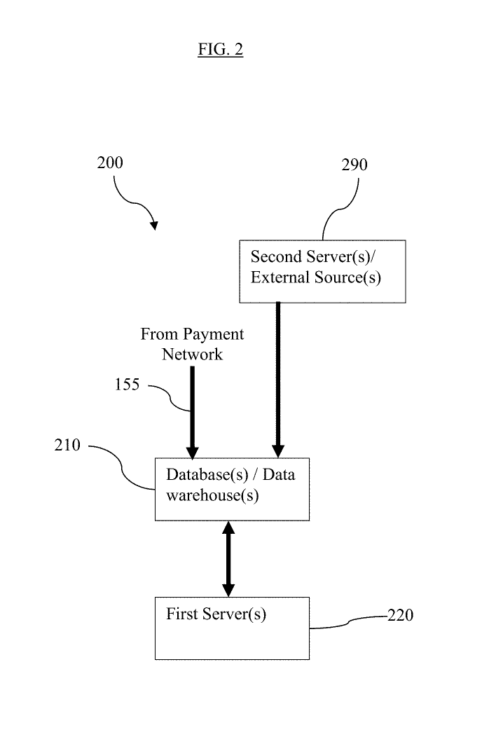

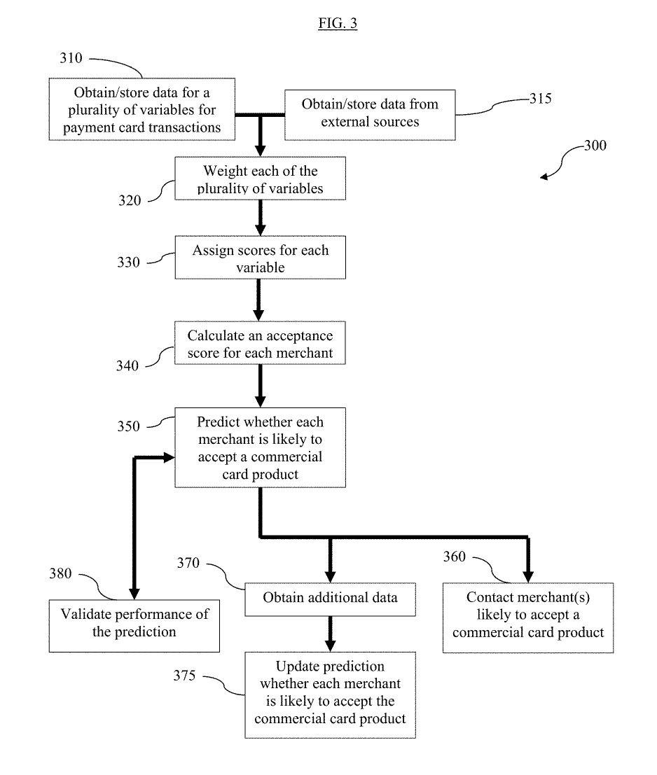

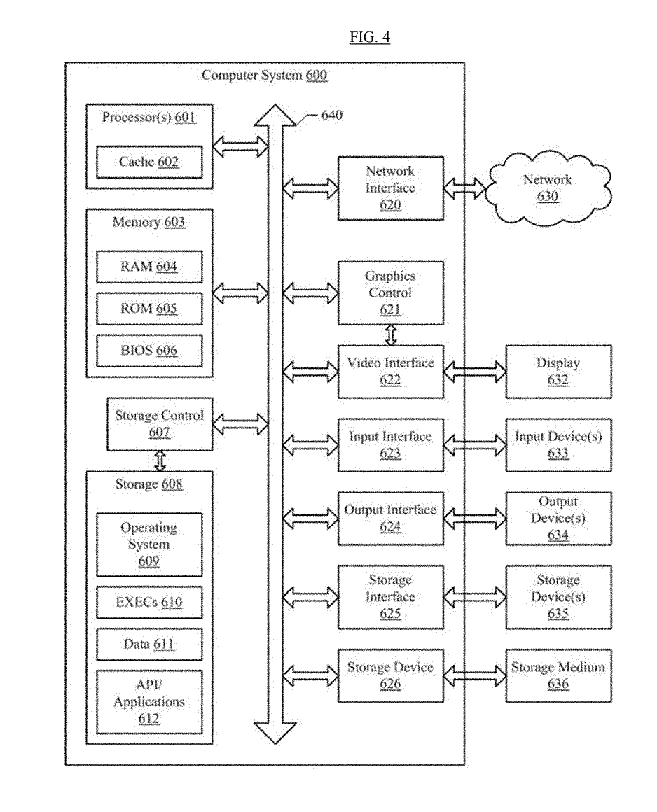

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, an exemplary embodiment of a payment networks for predicting acceptance of a commercial card product in accordance with the disclosed subject matter is shown in FIG. 1. An exemplary embodiment of a system for predicting acceptance of a commercial card product in accordance with the disclosed subject matter is shown in FIG. 2. FIG. 3 shows an exemplary embodiment of a method for predicting acceptance of a commercial card product in accordance with the disclosed subject matter. An exemplary embodiment of a computer system for use with the disclosed subject matter is shown in FIG. 4. While the present disclosed subject matter is described with respect to using methods, systems, networks, and media for predicting acceptance of a commercial card product, one skilled in the art will recognize that the disclosed subject matter is not limited to the illustrative embodiments. For example, the methods, systems, networks, and media for predicting acceptance of a payment card product can be used with a wide variety of settings, such as acceptance of a payment card product for individual consumers.

FIG. 1 depicts a diagram illustrating a representative payment network 100 according to an illustrative embodiment of the disclosed subject matter. Payment network 100 can allow for payment transactions in which merchants and card issuers do not necessarily have a one-to-one relationship. The payment network 100, for example and without limitation a credit card payment system, can utilize an electronic payment network 140, such as the MasterCard® payment card system interchange network. MasterCard® payment card system interchange network is a proprietary communications standard promulgated by MasterCard International Incorporated® based on the ISO 8583 message format for the exchange of financial transaction data between financial institutions that are customers of MasterCard International Incorporated. (MasterCard is a registered trademark of MasterCard International Incorporated located in Purchase, N.Y.)

As embodied herein, the payment network 100 for predicting acceptance of a commercial card product can include at least one merchant 110 connected to at least one electronic payment network 140, either directly or through an acquirer 120 via connection 115. At least one acquirer 140 can be connected to the electronic network 140, and each merchant 110 can be in communication with at least one acquirer 120 via the at least one payment network 140 or connection 115. At least one issuer 130 can be connected to the electronic network 140, and each acquirer 120 can be in communication with at least one issuer 130 via the electronic payment network 140.

For purpose of illustration and not limitation, in payment network 100, a financial institution, such as an issuer 130, can issue an account, such as a credit card account or a debit card account, to a cardholder (e.g., an individual consumer or a corporate or commercial customer), who can use the payment account card to tender payment for a purchase from a merchant 110 or to conduct a transaction at an ATM or website. To accept payment with the payment account card, merchant 110 can establish an account with a financial institution that is part of the financial payment system. This financial institution can be referred to as the “merchant bank” or the “acquiring bank,” or herein as “acquirer 120.” When a cardholder tenders payment for a purchase with a payment account card, the merchant, ATM, or website 110 can request authorization from acquirer 120 for the amount of the purchase. The request can be performed over the telephone, online via a website, or through the use of a point-of-sale terminal which can read the cardholder's account information from the magnetic stripe on the payment account card, from a smart card using contact pads, or contactlessly from a near-field communication device and communicate electronically with the transaction processing computers of acquirer 120. Alternatively, acquirer 120 can authorize a third party to perform transaction processing on its behalf. In this case, the point-of-sale terminal can be configured to communicate with the third party. Such a third party can be referred to as a “merchant processor” or an “acquiring processor.”

As embodied herein, using payment network 140, the computers of acquirer 120 or the merchant processor can communicate information regarding payment card transactions with computers of the issuer 130. For example and not limitation, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, the authorization request 125 can be declined or accepted, and an authorization response 135 can be transmitted from the issuer 130 to the acquirer 120, and then to the merchant, ATM, or website 110. The authorization request 125 can include account information identifying the merchant, location information (e.g., an address of the merchant), and transaction information, as discussed herein. The authorization response 135 can include, among other things, a result of the determination that the transaction is approved or declined and/or information about the status of the payment card or payment account.

For example and not limitation, at least one payment network server 150 can be connected to the electronic payment network 140 and configured to automatically capture the data representing a plurality of variables related to payment card transactions from the electronic payment network 140. Additionally, the payment network server can be connected to a system 200 for predicting acceptance of a commercial card product either by the electronic payment network 140 or a separate connection 155. As embodied herein, the payment network server 150 can be configured to only capture the data representing a plurality of variables related to payment card transactions with the permission of the cardholder. Additionally, the payment network server 150 can be configured to only capture the information regarding payment card transactions in accordance with applicable data privacy laws.

FIG. 2 depicts a block diagram illustrating a representative system 200 for predicting acceptance of a commercial card product according to an illustrative embodiment of the disclosed subject matter. The exemplary system 200 can include at least one database 210 configured to store data representing a plurality of variables related to payment card transactions for at least one merchant 110. The data warehouse or database 210 can be any suitable computer readable medium for storing data. For example and not limitation, the data warehouse or database 210 can be a relational database. The database 210 can store data representing a plurality of variables related to payment card transactions, as discussed herein. As embodied herein, database 210 can be configured to only store the information regarding payment card transactions with the permission of the cardholder. Additionally, the database 210 can be configured to only store the information regarding payment card transactions in accordance with applicable data privacy laws.

As embodied herein, at least one first server 220 can be coupled to the database and can be configured to weight each of the plurality of variables. The first server 220 can assign scores for each of the plurality of variables based on at least one predetermined threshold. An acceptance score for each merchant 110 can be calculated at the first server 220 by combining the scores for each of the plurality of variables for each merchant 110. The first server 220 can predict whether each merchant 110 is likely to accept a commercial card product based on the acceptance score. Additionally, each merchant 110 predicted to be likely to accept the commercial card product can be contacted.

For purpose of illustration and not limitation, at least one payment network server 150 can be connected to a payment network 140 and can be configured to automatically capture the data representing the plurality of variables from the payment network 140 and send the data representing the plurality of variables from the payment network server 150 to the database 210. For example, subject to permission of the cardholder and applicable data privacy laws, data for all transactions on payment network 140 can be stored at a data warehouse 210. The data stored in the data warehouse 210 can provide values for the variables. Additionally, the data in the data warehouse 210 can be updated at any suitable time interval, including by not limited to daily or in real time.

Additionally or alternatively, the data representing the plurality of variables can include data from external sources or a second server 290. For example and not limitation, the second server 290 can be configured to receive the data from the external sources and provide that data to the first server 220 and/or the database 210. Alternatively, the first server 220 can obtain the information directly from the external sources. For example and not limitation, the functionality of the first server 220 and the second server 290 can be implemented on a single server. The data from external sources can include any suitable data for predicting acceptance of a commercial card product, as described herein. For example and not limitation, the data from external sources can include at least one of an industry concentration of each merchant and each merchant's amount of card acceptance volume relative to total accounts receivables. For purpose of illustration, the industry concentration of each merchant can be determined from a U.S. IRS database. Additionally or alternatively, each merchant's total accounts receivables can be determined from that merchant's public financial statements.

FIG. 3 is a flow chart illustrating a representative method 300 implemented according to an illustrative embodiment of the disclosed subject matter. The exemplary network 100 of FIG. 1 and system 200 of FIG. 2, for purpose of illustration and not limitation, are discussed with reference to the exemplary method of FIG. 3.

As embodied herein, at 310, information regarding payment card transactions of at least one cardholder can be obtained and/or stored at a database 210, as discussed herein. For purpose of illustration and not limitation, obtaining the data representing the plurality of variables can include accessing the data representing the plurality of variables from a database 210. Additionally or alternatively, obtaining the data representing the plurality of variables can include automatically capturing the data representing the plurality of variables from a payment network 140 and storing the data representing the plurality of variables in a database 210, as described herein.

The data representing the plurality of variables can include any suitable data for predicting acceptance of a commercial card product, as described herein. For example and not limitation, the variables can include variables identified as useful for such prediction based on previous research, variables identified as useful for such prediction based on experimentation or data analysis, and/or variables based on any data communicated via the payment network 140. As embodied herein, the data representing the plurality of variables for each merchant 110 can include at least one of each merchant's share of transactions in a merchant category code (MCC), each merchant's share of volume in the MCC, each merchant's average transaction size, each merchant's variance of volume trend, each merchant's effective rate qualification, and each merchant's issuer concentration, all of which can be determined from data captured from the payment network 140 and/or stored in the database 210. For example and not limitation, the MCC can be used to organize each merchant 110 by business type. For example and not limitation, the MCC can be a four digit code for each business type. As embodied herein, each merchant's share of transactions in the MCC can be each merchant's total number of transactions divided by a total number of transactions in the MCC.

Additionally or alternatively, each merchant's share of volume in the MCC can be each merchant's total volume in currency divided by total volume in currency in the MCC. For purpose of illustration and not limitation, the currency can be any suitable currency, including but not limited to the currency used by the merchant or used by the issuer. For example, the currency can be dollars or euros. Each merchant's average transaction size can be each merchant's total volume in currency divided by each merchant's total number of transactions.

For purpose of illustration and not limitation, each merchant's variance of volume trend can be each merchant's volume change in a current time period minus each merchant's volume change in a previous time period. The current time period can be any suitable time period, and the previous time period can be any suitable time period of equal length prior to the current time period. For example and not limitation, the current time period can be a rolling 12 month period, and the previous time period can be a 12 month period immediately prior to the rolling 12 month period. Alternatively, the time periods can yearly or quarterly. For example, the current time period can be a year to date, and the previous time period can be a prior year to date. For purpose of illustration and not limitation, volume change can be expressed in percentage change over the time period. Additionally, time periods such as a 12 month rolling period can normalize or reduce the impact of seasonality, e.g., increased or decreased spending habits during a particular season or time of year.

As embodied herein, each merchant's effective rate qualification can be each merchant's issuing interchange fee divided by each merchant's total volume. For example, the issuing interchange fee can be the fee that each merchant 110 pays to issuer, which can be a variable percentage of each transaction. For purpose of illustration and not limitation, the interchange fee can be different for each merchant and/or different for different types of transactions. For example, the interchange fee can range based on different elements, such as the product used, the amount of data including in the transaction, wholesale pricing arrangements, reduced or preferred pricing arrangements, or the like. Additionally, the interchange fee can be capped or not capped. For purpose of illustration and not limitation, the effective rate qualification can be an average interchange fee, which can be calculated by the total issuing interchange fees paid by that merchant 110 in the current period divided by that merchant's total volume in the current period.

Additionally, as embodied herein, each merchant's issuer concentration can be each merchant's issuer volume divided by each merchant's total volume in the current time period minus each merchant's issuer volume divided by each merchant's total volume of the previous time period. For example and not limitation, the current and previous time periods can be the same as described above. For purpose of illustration and not limitation, the issuer volume can be the number of issuers 130 that the merchant 110 has conducted transactions with during the time period. For example, if a merchant 110 has conducted transactions with two issuers 130 during the current time period and the same merchant 110 conducted transactions with ten issuers 130 during the previous time period, the issuer concentration or that merchant 110 has increased, which can represent that a merchant is giving preferential treatment to certain customers or to certain issuers 130. Such a merchant 110 may be less likely to accept a commercial card product from additional customers.

Additionally or alternatively, the data representing the plurality of variables can include data from external sources 290. At 315, the data from the external sources can be received, obtained, and/or stored, for example by the first server 220 or second server 290. The data from the second server or external sources 290 can include any suitable data for predicting acceptance of a commercial card product, as described herein. For example and not limitation, the data from the second server or external sources 290 can include at least one of an industry concentration of each merchant and each merchant's amount of card acceptance volume relative to total accounts receivables. For purpose of illustration, the industry concentration of each merchant can be determined from a U.S. IRS database. Additionally or alternatively, each merchant's total accounts receivables can be determined from that merchant's public financial statements. As embodied herein, the data from external sources can be obtained and/or stored in any suitable manner. For example, the data can be manually retrieved and formatted for storage in a database. Additionally or alternatively, the data can be automatically obtained and/or stored, for example, by extracting and formatting the data from a website or by downloading the data from a third party, such as one or more information services companies. For example and not limitation, such information services companies may provide data with or without a subscription, including but not limited to Dun & Bradstreet, Inc., Oxxford Information Technology, or Hoovers.

At 320, each of the plurality of variables can be weighted, for example, by the first server 220. For purpose of illustration and not limitation, weighting each of the plurality of variables can include ranking each of the plurality of variables in order of importance and determining a weight for each of the plurality of variables based on a rank of each of the plurality of variables. Additionally or alternatively, at 330, scores for each of the plurality of variables can be assigned based on at least one predetermined threshold, for example, by the first server 220. For example and not limitation, assigning scores can include selecting at least one threshold for each variable and determining a score for each variable of each merchant 110 based on whether that variable is greater than or less than the respective threshold. Additionally, a plurality of thresholds can be selected for each variable. For example and not limitation, determining the score can include determining the score for each variable of each merchant 110 based on whether that variable is greater than, less than, or between the thresholds. As embodied herein, at least a minimum and a maximum score can be assigned to each variables based on the predetermined thresholds, and the score of each merchant 110 can be determined by how each variable of that merchant 110 compares to the thresholds.

For purpose of illustration and not limitation, Table 1 shows exemplary weighting, thresholds, and scoring for each of six exemplary variables. The exemplary variables can include each merchant's share of transactions in a merchant category code (MCC), each merchant's share of volume in the MCC, each merchant's average transaction size, each merchant's variance of volume trend, each merchant's effective rate qualification, and each merchant's issuer concentration, as described herein. Each variable can be assigned a weight based on order of importance. Each variable also has three ranges associated with the thresholds: a lowest range below a lower threshold, a middle range between the lower and an upper threshold, and a highest range above the upper threshold. A score is assigned for each range associated with each variable.

TABLE 1
Exemplary Weighting, Thresholds, and Assignment of Scores for Exemplary Variables

| Variable/Indication | | | | | |
|---|---|---|---|---|---|
| of Acceptance | Definition | Weighting | Threshold | | Score |
| Merchant's Share | Merchant's total | 10% | 0% | Low | 5 |
| of Transactions | number of | | 10% | Medium | 10 |
| | transactions/Total | | 20% | High | 5 |
| | number of | | | | |
| | transactions in | | | | |
| | MCC | | | | |
| Merchant's Share | Merchant's total | 10% | 0% | Low | 5 |
| of Volume | volume/Total | | 10% | Medium | 10 |
| | volume in MCC | | 20% | High | 5 |
| Average | Merchant's total | 18% | $0 | Low | 18 |
| Transaction Size | volume/Merchant's | | $500 | Medium | 14 |
| | number of | | $3,000 | High | 10 |
| | transactions | | | | |
| Volume Trend | Volume Change in | 23% | −100000000% | Declining | 10 |
| | Period 2 - Volume | | 0% | Stable | 18 |
| | Change in Period 1 | | 10% | Growing | 23 |
| Effective Rate | Merchant's Issuing | 16% | 0% | Data rate 3 | 16 |
| Qualification | Interchange | | 2.0% | Data rate 2 | 13 |
| | Fee/Merchant's | | 2.5% | Data rate 1 | 10 |
| | total volume | | | | |
| Change in Issuer | Issuer | 23% | −10000000 | Low | 10 |
| Concentration | Volume/Total | | 1 | Medium | 18 |
| | Volume of | | 3 | High | 23 |
| | Period 2 - | | | | |
| | Issuer | | | | |
| | Volume/Total | | | | |
| | Volume of Period 1 | | | | |
| Total | | 100% | | | 100 |

At 340, an acceptance score for each merchant 110 can be calculated by combining the scores for each of the variables for that merchant 110, for example, by the first server 220. The scores can be combined using any suitable technique. For example and not limitation, calculating the acceptance score for each merchant 110 can include calculating a sum of the scores for each of the variables for that merchant 110. Additionally or alternatively, calculating the acceptance score for each merchant 110 can include calculating an average or weighted average of the scores. For purpose of illustration and not limitation, referring to the score ranges for each variable as set forth in Table 1, a merchant's score can range from 50 to 100.

At 350, whether each merchant is likely to accept a commercial card product can be predicted based on the acceptance score, for example, by first server 220. For example and not limitation, a higher score can correspond to a merchant being more likely to accept a commercial card product from a commercial customer. For purpose of illustration and not limitation, the prediction can include determining whether the acceptance score is greater than a score threshold. Additionally or alternatively, a plurality of score thresholds can be selected, and determining the likelihood of acceptance for each merchant 110 can include determining whether the acceptance score is greater than, less than, or between the thresholds. For example and not limitation, predicting whether each merchant is likely to accept the commercial card product can include determining whether the acceptance score is greater than a high likelihood score threshold, determining whether the acceptance score is between the high likelihood score threshold and a low likelihood score threshold, or determining whether the acceptance score is below the low likelihood score threshold.

Table 2 shows exemplary score thresholds for using the acceptance score to predict whether each merchant is likely to accept a commercial card product. For example and not limitation, these score thresholds can correspond to the scoring depicted in Table 1. A score of 100 can indicate that the merchant has a very strong likelihood of additional acceptance. Additionally, a score from 72 to 100 can indicate a high likelihood of additional acceptance; a score from 60 to 71 can indicate a medium likelihood of additional acceptance; and a score from 0 to 59 can indicate a low likelihood of additional acceptance.

TABLE 2
Exemplary Acceptance Score Thresholds

| Likelihood of | Min | Max |
|---|---|---|
| Acceptance | Score | Score |
| High | 72 | 100 |
| Medium | 60 | 71 |
| Low | 0 | 59 |

Table 3 shows exemplary acceptance score calculations for hypothetical merchants. The merchants can be, for example, carriers. The columns can show the following variables for each hypothetical carrier: total volume for the year to date (through the third quarter of 2015), each merchant's share of transactions in a merchant category code (MCC), each merchant's share of volume in the MCC, each merchant's average transaction size, each merchant's variance of volume trend, each merchant's effective rate qualification, each merchant's number of issuers in the previous period (2014), each merchant's number of issuers in the current period (2015), the change in number of issuers for each merchant between the two time periods, and each merchant's issuer concentration, as described herein. Referring also to the thresholds from Table 2, each of Carriers 1, 3, and 9 has a high likelihood of additional acceptance, and each of Carriers 5-7 has a low likelihood of additional acceptance. The other carriers (Carriers 2, 4, 8, and 10) have a medium likelihood of acceptance.

TABLE 3
Exemplary Acceptance Score Calculations for Hypothetical Carriers

| Merchant | YTD Q3 | Share | Share | | Volume Trend | Effective Rate | 2014 # of | 2015 # of | Change in # of | All Issuer | |
|---|---|---|---|---|---|---|---|---|---|---|---|
| Name | 2015 Volume | Trx | Vol | ATS | Variance | Qualification | Issuers | Issuers | Issuers | Concentration | Score |
| Carrier 1 | $536,701,710 | High | High | Medium | Declining | Data rate | 37 | 40 | 3 | High | 73 |
| | | | | | | 3 | | | | | |
| Carrier 2 | $327,706,025 | High | High | Medium | Declining | Data rate | 38 | 40 | 2 | Medium | 68 |
| | | | | | | 3 | | | | | |
| Carrier 3 | $15,913,814 | Low | Low | Low | Declining | Data rate | 24 | 29 | 5 | High | 74 |
| | | | | | | 2 | | | | | |
| Carrier 4 | $556,425 | Low | Low | High | Growing | Data rate | 9 | 5 | −4 | Low | 63 |
| | | | | | | 1 | | | | | |
| Carrier 5 | $333,485 | Low | Low | Medium | Declining | Data rate | 12 | 11 | −1 | Low | 57 |
| | | | | | | 2 | | | | | |
| Carrier 6 | $203,841 | Low | Low | High | Stable | Data rate | 9 | 7 | −2 | Low | 58 |
| | | | | | | 1 | | | | | |
| Carrier 7 | $115,450 | Low | Low | Medium | Declining | Data rate | 8 | 8 | 0 | Low | 54 |
| | | | | | | 1 | | | | | |
| Carrier 8 | $71,139 | Low | Low | Medium | Growing | Data rate | 10 | 8 | −2 | Low | 70 |
| | | | | | | 2 | | | | | |
| Carrier 9 | $3,400 | Low | Low | Low | Stable | Data rate | 1 | 2 | 1 | Medium | 74 |
| | | | | | | 1 | | | | | |
| Carrier 10 | $1,830 | Low | Low | Low | Declining | Data rate | 5 | 5 | 0 | Low | 64 |
| | | | | | | 3 | | | | | |

Additionally, as embodied herein, at 360, each merchant predicted to be likely to accept the commercial card product can be contacted. For purpose of illustration and not limitation, contacting each merchant can include the payment network service provider directly contacting each merchant. Additionally or alternatively, the payment network service provider can provide information identifying each merchant predicted to be likely to accept the commercial card to an issuer, and the issuer can contact each identified merchant. Additionally or alternatively, the issuer can provide the information identifying each merchant to a commercial customer so the commercial customer can contact each merchant predicted to be likely to accept the commercial card. Alternatively, rather than contacting the merchant directly, any one of the service provider, the issuer, or the commercial customer can contact the merchant's acquirer. Additionally, any one of the service provider, the issuer, or the commercial customer can offer the merchant (directly or through its acquiring bank) incentives to increase the likelihood of acceptance. For example and not limitation, the incentives can be any suitable incentive, including but not limited to discounted rates, reduced or enhanced pricing, or the like.

As embodied herein, the information identifying each merchant's likelihood to accept the commercial card product can be provided in any suitable format. For example and not limitation, the information can be provided in one or more lists, tables, spreadsheets, graphical displays, an application programming interface (API) accessible to authorized third parties, or any suitable combination thereof. Additionally, the format of the information can be configurable by a user.

Additionally or alternatively, the information identifying each merchant's likelihood to accept the commercial card product can be provided in a customizable alert. For example and not limitation, such an alert can include one or more emails, text messages, graphical displays, an API accessible to authorized third parties, or any suitable combination thereof. Additionally, the alert can be sent to an individual entity or a group of entities. For example, an issuer or a group of issuers may request an alert be broadcast when a new merchant is added to the data or a change in an existing merchant's score occurs. Additionally or alternatively, the information identifying each merchant's likelihood to accept the commercial card product can be combined with or into other products, including by not limited to data analytics products such as MasterCard® Merchant Match Tool, MasterCard® Smart Data, and/or MasterCard® Portfolio Analytics.

For example and not limitation, the configurable or customizable features can be selected using any suitable technique, including by not limited to graphical elements displayed on a display, as described herein. Such graphical elements can include pull down menus, checkboxes, buttons, text boxes, or the like. The configurable or customizable features can include but are not limited to which variables to use, which time periods to use, which thresholds to use, which merchants to include, which MCCs to use, which product codes to include (e.g., Small Business, Mid-Large Market, etc.), acceptance for Card Present vs Card Not Present (e.g., Virtual Card), whether to includes merchant(s) already accepting from a specific issuer, location of merchants, how to output or display the acceptance score and/or prediction information, whether to send alerts, and what information to include in alerts.

For purpose of illustration and not limitation, at 370, new or additional data can be obtained. For example and not limitation, the data can be obtained in real time from the payment network 140 and/or payment network server 150, as described herein. At 375, the prediction for each merchant can be updated based on the new data. For example and not limitation, the new data may result in the value of a variable for a given merchant 110 changing with respect to a threshold, thus a new score can be assigned for that variable for that merchant 110 (330), a new acceptance score can be calculated for that merchant 110 (340), and a new prediction of likelihood of acceptance can be made for that merchant 110 (350).

For example and not limitation, at 380, the prediction of likelihood of acceptance for at least one merchant 110 can be validated. For example and not limitation, if the likelihood of acceptance was correctly predicted, then the prediction can be determined to be valid. Alternatively, if the likelihood of acceptance was not correctly predicted, the method 300 can be adjusted to enhance performance. For example and not limitation, different variables, different weights, different scores and/or different thresholds can be selected. Additionally, the selection(s) can be manual or automated, e.g., based on the results of validation.

FIG. 4 is a block diagram illustrating further details of a representative computer system according to an illustrative embodiment of the disclosed subject matter.

The systems and techniques discussed herein can be implemented in a computer system. As an example and not by limitation, as shown in FIG. 4, the computer system having architecture 600 can provide functionality as a result of processor(s) 601 executing software embodied in one or more tangible, non-transitory computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface 620. The software can cause processor(s) 601 to execute particular processes or particular parts of particular processes described herein, including defining data structures stored in memory 603 and modifying such data structures according to the processes defined by the software. An exemplary input device 633 can be, for example, a keyboard, a pointing device (e.g. a mouse), a touchscreen display, a microphone and voice control interface, or the like to capture user input coupled to the input interface 623 to provide data and/or user input to the processor 601. An exemplary output device 634 can be, for example, a display (e.g. a monitor) or speakers coupled to the output interface 624 to allow the processor 601 to present a user interface, visual content, and/or audio content. Additionally or alternatively, the computer system 600 can provide an indication to the user by sending text or graphical data to a display 632 coupled to a video interface 622. Furthermore, any of the above components can provide data to or receive data from the processor 601 via a computer network 630 coupled the communication interface 620 of the computer system 600. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 601 includes hardware for executing instructions, such as those making up a computer program. As an example and not by way of limitation, to execute instructions, processor 601 can retrieve (or fetch) the instructions from an internal register, an internal cache 602, memory 603, or storage 608; decode and execute them; and then write one or more results to an internal register, an internal cache 602, memory 603, or storage 608. In particular embodiments, processor 601 can include one or more internal caches 602 for data, instructions, or addresses. This disclosure contemplates processor 601 including any suitable number of any suitable internal caches, where appropriate. As an example and not by way of limitation, processor 601 can include one or more instruction caches 602, one or more data caches 602, and one or more translation lookaside buffers (TLBs). Instructions in the instruction caches 602 can be copies of instructions in memory 603 or storage 608, and the instruction caches 602 can speed up retrieval of those instructions by processor 601. Data in the data caches 602 can be copies of data in memory 603 or storage 608 for instructions executing at processor 601 to operate on; the results of previous instructions executed at processor 601 for access by subsequent instructions executing at processor 601 or for writing to memory 603 or storage 608; or other suitable data. The data caches 602 can speed up read or write operations by processor 601. The TLBs can speed up virtual-address translation for processor 601. In some embodiments, processor 601 can include one or more internal registers for data, instructions, or addresses. This disclosure contemplates processor 601 including any suitable number of any suitable internal registers, where appropriate. Where appropriate, processor 601 can include one or more arithmetic logic units (ALUs); be a multi-core processor; or include one or more processors 601. Although this disclosure describes and illustrates a particular processor, this disclosure contemplates any suitable processor.

In some embodiments, memory 603 includes main memory for storing instructions for processor 601 to execute or data for processor 601 to operate on. As an example and not by way of limitation, computer system 600 can load instructions from storage 608 or another source (such as, for example, another computer system 600) to memory 603. Processor 601 can then load the instructions from memory 603 to an internal register or internal cache 602. To execute the instructions, processor 601 can retrieve the instructions from the internal register or internal cache 602 and decode them. During or after execution of the instructions, processor 601 can write one or more results (which can be intermediate or final results) to the internal register or internal cache 602. Processor 601 can then write one or more of those results to memory 603. In some embodiments, processor 601 executes only instructions in one or more internal registers or internal caches 602 or in memory 603 (as opposed to storage 608 or elsewhere) and operates only on data in one or more internal registers or internal caches or in memory 603 (as opposed to storage 608 or elsewhere). One or more memory buses (which can each include an address bus and a data bus) can couple processor 601 to memory 603. Bus 640 can include one or more memory buses, as described below. In particular embodiments, one or more memory management units (MMUs) reside between processor 601 and memory 603 and facilitate accesses to memory 603 requested by processor 601. In some embodiments, memory 603 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 603 can include one or more memories 604, where appropriate. Although this disclosure describes and illustrates particular memory, this disclosure contemplates any suitable memory.

In some embodiments, storage 608 includes mass storage for data or instructions. As an example and not by way of limitation, storage 608 can include a hard disk drive (HDD), a floppy disk drive, flash memory, an optical disc, a magneto-optical disc, magnetic tape, or a Universal Serial Bus (USB) drive or a combination of two or more of these. Storage 608 can include removable or non-removable (or fixed) media, where appropriate. Storage 608 can be internal or external to computer system 600, where appropriate. In some embodiments, storage 608 is non-volatile, solid-state memory. In some embodiments, storage 608 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. Storage 608 can include one or more storage control units facilitating communication between processor 601 and storage 608, where appropriate. Where appropriate, storage 608 can include one or more storages 608. Although this disclosure describes and illustrates particular storage, this disclosure contemplates any suitable storage.

In some embodiments, input interface 623 and output interface 624 can include hardware, software, or both, providing one or more interfaces for communication between computer system 600 and one or more input device(s) 633 and/or output device(s) 634. Computer system 600 can include one or more of these input device(s) 633 and/or output device(s) 634, where appropriate. One or more of these input device(s) 633 and/or output device(s) 634 can enable communication between a person and computer system 600. As an example and not by way of limitation, an input device 633 and/or output device 634 can include a keyboard, keypad, microphone, monitor, mouse, printer, scanner, speaker, still camera, stylus, tablet, touch screen, trackball, video camera, another suitable input device 633 and/or output device 634 or a combination of two or more of these. An input device 633 and/or output device 634 can include one or more sensors. This disclosure contemplates any suitable input device(s) 633 and/or output device(s) 634 and any suitable input interface 623 and output interface 624 for them. Where appropriate, input interface 623 and output interface 624 can include one or more device or software drivers enabling processor 601 to drive one or more of these input device(s) 633 and/or output device(s) 634. Input interface 623 and output interface 624 can include one or more input interfaces 623 or output interfaces 624, where appropriate. Although this disclosure describes and illustrates a particular input interface 623 and output interface 624, this disclosure contemplates any suitable input interface 623 and output interface 624.

As embodied herein, communication interface 620 can include hardware, software, or both providing one or more interfaces for communication (such as, for example, packet-based communication) between computer system 600 and one or more other computer systems 600 or one or more networks. As an example and not by way of limitation, communication interface 620 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 620 for it. As an example and not by way of limitation, computer system 600 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 600 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 can include any suitable communication interface 620 for any of these networks, where appropriate. Communication interface 620 can include one or more communication interfaces 620, where appropriate. Although this disclosure describes and illustrates a particular communication interface, this disclosure contemplates any suitable communication interface.

In some embodiments, bus 640 includes hardware, software, or both coupling components of computer system 600 to each other. As an example and not by way of limitation, bus 640 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 640 can include one or more buses 604, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A method for predicting acceptance of a commercial card product, comprising:
obtaining data representing a plurality of variables related to payment card transactions for at least one merchant;
weighting each of the plurality of variables;
assigning scores for each of the plurality of variables based on at least one predetermined threshold;
calculating an acceptance score for each merchant by combining the scores for each of the plurality of variables for each merchant;
predicting whether each merchant is likely to accept a commercial card product based on the acceptance score; and
contacting each merchant predicted to be likely to accept the commercial card product.

2. The method of claim 1, wherein obtaining the data representing the plurality of variables comprises accessing the data representing the plurality of variables from a database.

3. The method of claim 1, wherein obtaining the data representing the plurality of variables comprises automatically capturing the data representing the plurality of variables from a payment network and storing the data representing the plurality of variables in a database.

4. The method of claim 1, wherein the data representing the plurality of variables comprises at least one of each merchant's share of transactions in a merchant category code (MCC), each merchant's share of volume in the MCC, each merchant's average transaction size, each merchant's variance of volume trend, each merchant's effective rate qualification, and each merchant's issuer concentration.

5. The method of claim 4, wherein:
each merchant's share of transactions in the MCC comprises each merchant's total number of transactions divided by a total number of transactions in the MCC,
each merchant's share of volume in the MCC comprises each merchant's total volume in currency divided by total volume in currency in the MCC,
each merchant's average transaction size comprises each merchant's total volume divided by each merchant's total number of transactions,
each merchant's variance of volume trend comprises each merchant's volume change in a current time period minus each merchant's volume change in a previous time period,
each merchant's effective rate qualification comprises each merchant's issuing interchange fee divided by each merchant's total volume, and
each merchant's issuer concentration comprises each merchant's issuer volume divided by each merchant's total volume in the current time period minus each merchant's issuer volume divided by each merchant's total volume of the previous time period.

6. The method of claim 5, wherein the current time period is a rolling 12 month period and the previous time period is a 12 month period prior to the rolling 12 month period.

7. The method of claim 5, wherein the current time period is a year to date and the previous time period is a prior year to date.

8. The method of claim 1, wherein the data representing the plurality of variables comprises data from external sources, the data from external sources comprising at least one of an industry concentration of each merchant and each merchant's amount of card acceptance volume relative to total accounts receivables.

9. The method of claim 1, wherein weighting each of the plurality of variables comprises:
ranking each of the plurality of variables in order of importance; and
determining a weight for each of the plurality of variables based on a rank of each of the plurality of variables.

10. The method of claim 1, wherein assigning scores for each of the plurality of variables based on at least one predetermined threshold comprises:
selecting at least one threshold for each of the plurality of variables; and
determining a score for each of the plurality of variables based on whether each of the plurality of variables is greater than or less than each respective threshold.

11. The method of claim 10, wherein:
selecting at least one threshold comprises selecting a plurality of thresholds for each of the plurality of variables; and
determining the score comprises determining the score for each of the plurality of variables based on whether each of the plurality of variables is greater than, less than, or between each respective plurality of thresholds.

12. The method of claim 1, wherein calculating the acceptance score for each merchant comprises calculating a sum of the scores for each of the plurality of variables for each merchant.

13. The method of claim 1, wherein calculating the acceptance score for each merchant comprises calculating an average of the scores for each of the plurality of variables for each merchant.

14. The method of claim 1, wherein predicting whether each merchant is likely to accept the commercial card product comprises determining whether the acceptance score is greater than a score threshold.

15. The method of claim 1, wherein predicting whether each merchant is likely to accept the commercial card product comprises:
determining whether the acceptance score is greater than a high likelihood score threshold,
determining whether the acceptance score is between the high likelihood score threshold and a low likelihood score threshold, or
determining whether the acceptance score is below the low likelihood score threshold.

16. The method of claim 1, contacting each merchant predicted to be likely to accept the commercial card product comprises at least one of:
a payment network service provider directly contacting each merchant predicted to be likely to accept the commercial card;
the payment network service provider providing information identifying each merchant predicted to be likely to accept the commercial card to an issuer to contact each merchant predicted to be likely to accept the commercial card; or
the issuer providing the information identifying each merchant predicted to be likely to accept the commercial card to a commercial customer of the issuer to contact each merchant predicted to be likely to accept the commercial card.

17. A system for predicting acceptance of a commercial card product, comprising:
at least one database configured to:
store data representing a plurality of variables related to payment card transactions for at least one merchant;
at least one first server, coupled to the at least one database, and configured to:
weight each of the plurality of variables;
assign scores for each of the plurality of variables based on at least one predetermined threshold;
calculate an acceptance score for each merchant by combining the scores for each of the plurality of variables for each merchant;
predict whether each merchant is likely to accept a commercial card product based on the acceptance score; and
contact each merchant predicted to be likely to accept the commercial card product.

18. The system of claim 17, further comprising:
at least one payment network server connected to a payment network and configured to automatically capture the data representing the plurality of variables from the payment network and send the data representing the plurality of variables from the payment network server to the database.

19. The system of claim 17, wherein the data representing the plurality of variables comprises data from external sources, further comprising:
at least one second server configured to receive the data from the external sources.

20. A payment network for predicting acceptance of a commercial card product, comprising:
a plurality of merchants connected to at least one electronic payment network;
at least one acquirer connected to the at least one electronic network, each merchant in communication with at least one of the at least one acquirer via the at least one payment network;
at least one issuer connected to the at least one electronic network, each acquirer in communication with at least one of the at least one issuer via the at least one payment network;
at least one payment network server connected to the at least one electronic network and configured to automatically capture the data representing the plurality of variables from the payment network;
at least one database configured to:
receive the data representing the plurality of variables from the payment network server;
store the data representing a plurality of variables related to payment card transactions for at least one merchant;
at least one first server, coupled to the at least one database, and configured to:
weight each of the plurality of variables;
assign scores for each of the plurality of variables based on at least one predetermined threshold;
calculate an acceptance score for each merchant by combining the scores for each of the plurality of variables for each merchant;
predict whether each merchant is likely to accept a commercial card product based on the acceptance score; and
contact each merchant predicted to be likely to accept the commercial card product.
